(19) United States
(12) Patent Application Publication
(10) Pub. No.: US 2026/0134707 A1
(43) Pub. Date: May 14, 2026

(54) UAV Perspective Text Detection Model Based on Boundary Adaptation

(71) Applicant: Chongqing University of Technology, Chongqing (CN)

(72) Inventors: Jun Liu, Chongqing (CN); Jianxun Zhang, Chongqing (CN)

(21) Appl. No.: 19/002,790

(22) Filed: Dec. 27, 2024

(30) Foreign Application Priority Data
Nov. 12, 2024 (CN) 2024116098573

(51) Int. Cl. G06V 30/18; G06V 10/80; G06V 20/17

(52) U.S. Cl. CPC G06V 30/18; G06V 10/80; G06V 20/17

(57) ABSTRACT

The invention relates to the technical field of UAV visual angle text detection, and discloses an UAV perspective text detection model based on boundary adaptation. Firstly, ResNet50 is used as a backbone network, and a hybrid text attention mechanism is proposed, and it is introduced into a feature extraction module to enhance the perception of text areas. Finally, the local feature extractor is introduced into the transformer of the text detail boundary iterative optimization module, so that the precise optimization and positioning of the text boundary under complex background interference are realized, and complex post-processing steps are avoided. A large number of experiments on challenging text detection data sets and UAV-based text detection data sets verify the high robustness and advanced performance of our proposed method, which lays a solid foundation for practical application.

### TECHNICAL FIELD

The invention relates to the technical field of UAV visual angle text detection, in particular to an UAV perspective text detection model based on boundary adaptation.

### BACKGROUND

With the rapid development of UAV technology, UAVs are widely used in daily life and professional fields, including military reconnaissance, environmental monitoring, logistics, urban planning and disaster relief. Text detection and recognition in UAV images is of great significance for enhancing UAV's environmental awareness. Because the text usually contains important geographical location information, facility names, direction signs and advertising content. Extracting these text information can significantly enhance the UAV's environmental perception ability in complex environment, so as to better understand the surrounding environment and improve the accuracy of autonomous decision-making and path planning. In addition, for the development of smart cities, it helps to analyze the commercial layout and the distribution of community street advertisements. However, aerial images taken from the perspective of unmanned aerial vehicles have challenges such as complex background information, diverse text shapes and directions, small-scale text and occlusion, which makes the task of text detection particularly difficult.

The existing text detection technology is mainly aimed at images taken in natural scenes. However, images taken by drones have unique challenges and needs. First of all, drones usually shoot images from the air, resulting in text appearing in various shapes and directions. Secondly, drones often shoot at a high altitude, resulting in small text size and significant background interference. In addition, due to the dynamic characteristics of UAV flight, the same text area may be photographed from multiple angles. Finally, due to the illumination changes caused by different time and weather conditions, shadows and highlights may appear in the image, which further increases the complexity of text detection. Therefore, it is very important to develop a text detection model specifically for UAV perspective. By introducing boundary adaptive technology, the detection ability of the model in complex scenes has been effectively enhanced, which can meet the needs of practical applications.

At present, popular text detection methods can be roughly divided into two categories: regression-based methods and segmentation-based methods. The method based on regression is used to predict the boundary coordinates of a text box, which does not require additional post-processing operations, thus improving the calculation efficiency and showing good performance in various text formats. However, these methods are unstable when dealing with small-scale and dense texts, and it is difficult to obtain satisfactory results when facing texts with complex background information.

For segmentation-based text detection methods, such as Pan and DBNet, they use pixel-level text area mask, which usually provides higher accuracy than regression-based methods. Because it can capture the geometric structure of the text, this method can achieve better results when dealing with texts with various shapes and directions. In addition, the segmentation method can block the text area, which makes it perform better when dealing with dense text and complex background. However, this method usually requires complex post-processing steps to allocate pixel groups to text areas, which requires a lot of labeling data and computing resources.

These methods usually rely on Convolutional Neural Network (CNN), but CNN often ignores the long-distance dependence and global spatial relationship between texts, making it more sensitive to noise areas in texts. However, in the task of text detection from the perspective of UAV, the text may appear in various scales, directions and shapes, and will be affected by complex background interference. Therefore, global features and long-distance dependence are very important for accurate text detection. In addition, the commonly used CNN backbone networks, such as ResNet and VGG, provide coarse-grained high-resolution features, which are useful for large-scale text detection, but not conducive to detecting small-scale text examples.

Therefore, it is necessary to provide a UAV perspective text detection model based on boundary adaptation to solve the above technical problems.

### SUMMARY

In order to solve the above technical problems, the present invention provides an UAV perspective text detection model based on boundary adaptation.

The UAV perspective text detection model based on boundary adaptation provided by the invention comprises the following components:
A hybrid text attention mechanism (HTAM), which is used to enhance the perception of text areas in the feature extraction stage;
A spatial feature fusion module (SFFM), which is used to adaptively fuse text features of different scales, and to effectively integrate the output features of low-level semantics and high-level semantics, so as to enhance the representation ability of features, enrich semantic information, and finally improve the model's understanding of image content and perception of texts of different scales;
A text detail transformer (TDT), including local feature extractor (LFE), which is used to optimize the iterative thinning process of text boundaries.

Preferably, the hybrid text attention mechanism (HTAM) is divided into two parts: a channel attention mechanism and a spatial attention mechanism, so as to reduce the detection omissions caused by visual angle change, illumination shadow and occlusion.

Preferably, the spatial feature fusion module (SFFM) realizes the fusion of high-level and low-level features through weighted feature maps, which enhances the detection ability of the model for texts of different scales.

Preferably, the text detail transformer (TDT) improves the ability of the model to extract local information from the feature map by introducing the local feature extractor (LFE) into the transformer block, thus optimizing the refinement of the text boundary.

Preferably, the channel attention mechanism introduces an efficient channel attention aggregation mechanism (A-ECA): the detailed texture features related to the text boundary are extracted by maximizing the pool operation of the input feature map, thus enhancing the perception of the text boundary; At the same time, the overall information of the image area is captured by average pooling, which is convenient to understand the overall image structure and background, which are contextual features related to the target; Therefore, these two processing methods are simultaneously applied to the input feature map; After processing, the two generated feature maps are connected, and the spatial information of the feature maps is aggregated by merging the average pooled feature and the maximum pooled feature.

Preferably, the channel attention mechanism also introduces a local cross-channel interaction strategy and an adaptive one-dimensional convolution structure to achieve a more comprehensive cross-channel information exchange. Through network learning, different weights corresponding to different channels on the feature map are obtained, thus providing more accurate attention information along the channel dimension.

The invention provides a method for detecting the perspective text of an unmanned aerial vehicle by using the UAV perspective text detection model based on boundary adaptation, which comprises the following steps:
Using hybrid text attention mechanism (HTAM) to extract image features;
Multi-scale features are fused by spatial feature fusion module (SFFM).

Text detail transformer (TDT) is used to iteratively optimize the text boundary to improve the accuracy of detection.

Compared with the related art, the UAV perspective text detection model based on boundary adaptation provided by the invention has the following beneficial effects:

The invention innovatively creates a data set for UAV visual angle text detection.

The hybrid text attention mechanism (HTAM) proposed in the invention improves the precision of the model under the conditions of complex background, diverse visual angles and low contrast, aiming at the text characteristics from the perspective of unmanned aerial vehicles; This method improves the convergence of training and the robustness of the model, and significantly improves the performance of text detection from the perspective of UAV.

Aiming at the common small-scale text problems from the perspective of unmanned aerial vehicles, the invention provides an innovative spatial feature fusion module (SFFM). By integrating feature maps from different receptive fields, the method of the invention shows remarkable effectiveness on the UAV visual angle text detection data set containing a large number of small-scale text examples.

By introducing the local feature extractor (LFE) into the iterative boundary optimization module based on Transformer, the invention enhances its ability to extract local information from the feature map. This improvement reduces the interference of complex background in UAV perspective image, and significantly improves the effect of text boundary optimization.

A large number of experiments on private UAV data sets and public data sets show that the method of the invention has reached an advanced level in performance and efficiency, and shows a good application prospect.

### BRIEF DESCRIPTION OF DRAWINGS

FIG. 1 is an illustration of the use of a text detail boundary iterative optimization module to refine rough text boundaries in the present invention: (a) backbone network and boundary proposal module generate rough text boundaries; (b) the text detail boundary iterative optimization module is used to iteratively refine the rough text boundary, so as to obtain a fine text boundary map;

FIG. 2 is a frame diagram of the UAV perspective text detection model based on boundary adaptation proposed by the present invention;

FIG. 3 is a backbone network diagram for feature extraction;

FIG. 4 is a structural diagram of HTAM;

FIG. 5 is a structural diagram of SFFM;

FIG. 6 is the encoder structure diagram of TDT.

### DETAILED DESCRIPTION OF EMBODIMENTS

The present invention will be further described with reference to the attached drawings and embodiments.

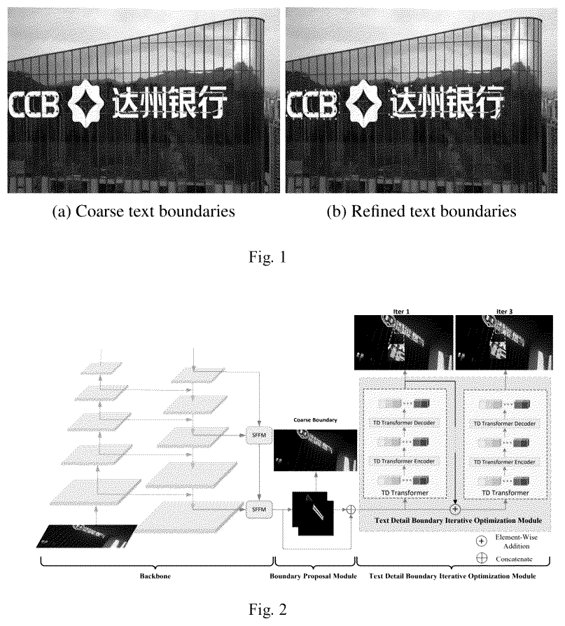

In this paper, a DADNet framework for text detection from the perspective of UAV is proposed, which makes full use of the advantages of Transformer and CNN. Specifically, our model consists of three main components: feature extraction backbone network, rough boundary box generation module and boundary refinement in boundary iterative optimization module. DADNet improves the model performance in the following three aspects:
(1) A hybrid text attention mechanism (HTAM) is introduced, which combines the spatial and channel attention mechanisms and endows the model with the ability of position perception and feature selection. This mechanism reduces the detection omissions caused by visual angle change, illumination shadow and occlusion, and enhances the robustness of the model and the perception ability of text features.
(2) Aiming at the problem of text information with different scales in UAV perspective images, the spatial feature fusion module (SFFM) is designed. This module integrates the features of low-level language output and high-level semantic output, and realizes the integration of high-level and low-level features. The weighted features calculated by this module are similar to the spatial attention mechanism, which promotes the selection and integration of features.
(3) The text detail transformer (TDT) is designed in the boundary iterative optimization module, and the boundary information of the text area is further enhanced by introducing the local feature extractor (LFE) into the original transformer block. Specifically, by using LFE to process the feature map to obtain local information, better boundary features of text areas can be obtained, which has a positive impact on the boundary optimization of text features. An example of the result is shown in FIG. 1.

In order to verify the effectiveness of DADNet, we collected images from UAV data sets (such as VisDrone2019 and UAVid), filtered the text data of UAV perspective, labeled it and created a UAV text data set for UAV perspective text detection. In addition, we further evaluate the performance of the model on challenging text detection data sets (such as Total-Text and CTW1500). Our model has achieved the most advanced results on these data sets.

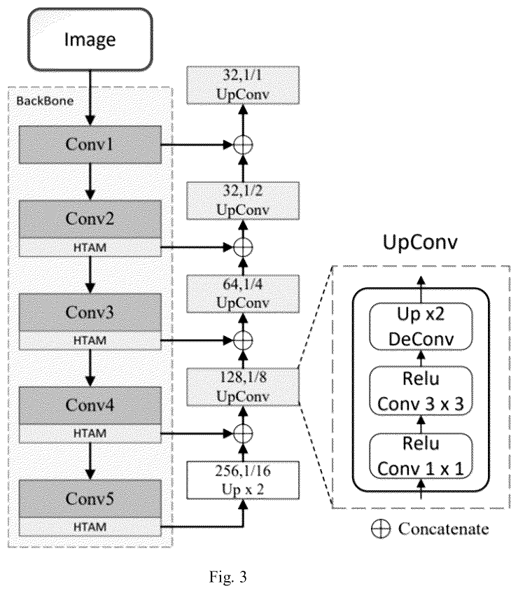

As shown in FIG. 2, the UAV perspective text detection model framework based on boundary adaptation proposed by the present invention takes ResNet50 as the backbone network for feature extraction. In order to enhance the sensitivity of the model to the text features, the higher-order attention mechanism (HTAM) is introduced. FIG. 3 illustrates our backbone network. Based on the multi-level feature fusion strategy, the spatial feature fusion module is adopted to maintain the spatial resolution and make full use of the multi-level information. Then the extracted features are passed to the boundary proposal module, which generates a rough text boundary proposal for each text area, and each boundary proposal consists of N control points, representing a potential text instance. Using these obtained prior information, the text boundary detail iteration module refines the text boundary. Finally, accurate text boundaries are obtained.

In the following, the hybrid text attention mechanism (HTAM), spatial feature fusion module (SFFM) and text detail transformer (TDT) will be described in detail:

### 1. Hybrid Text Attention Mechanism (HTAM):

The application of attention mechanism in deep learning is of great significance. In computer vision tasks, by allowing the model to assign different attention weights to different regions of the image, the model can better focus on the region of interest, thus improving the performance and generalization ability. This leads to the improvement of performance and adaptability.

In text detection from the perspective of UAV, the use of attention mechanism shows positive effects for the following reasons: First, the input data of this task usually contains complex natural scenes, and there are a lot of interferences, such as complex background, occlusion, noise, changes in natural lighting and texts from different angles. By adopting the attention mechanism, the model can selectively pay attention to the important image areas related to the text and ignore other parts of the image. This improves the accuracy and robustness of detection. In addition, there may be significant changes in the shape, size, font and spatial arrangement of characters in the text from the perspective of drones. Attention mechanism can help the model adapt to these changes and better focus and understand the text area.

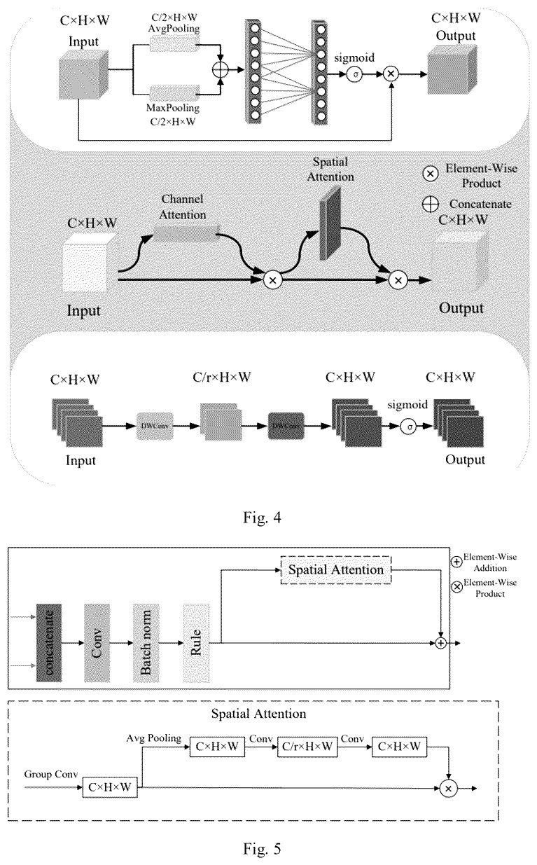

As shown in FIG. 4, hybrid text attention mechanism (HTAM) can be divided into two parts: channel attention mechanism and spatial attention mechanism. For the channel attention mechanism, an efficient channel attention aggregation mechanism (A-ECA) is introduced. By maximizing the input feature map, the detailed texture features related to the text boundary are extracted, thus enhancing the perception of the text boundary. At the same time, the overall information of the image area is captured by average pooling, which is convenient to understand the overall image structure and background, which are contextual features related to the target. Therefore, these two processing methods are simultaneously applied to the input feature map. After processing, the two generated feature maps are connected, and the spatial information of the feature maps is aggregated by merging the average pooled feature and the maximum pooled feature. In addition, a local cross-channel interaction strategy and an adaptive one-dimensional convolution structure are introduced to realize more comprehensive cross-channel information exchange. Through network learning, different weights corresponding to different channels on the feature map are obtained, thus providing more accurate attention information along the channel dimension.

The specific implementation involves decomposing the input feature map X= [symbol] ^{N×C} into Xₐ= [symbol] ^{N×C/2} and Xₘ= [symbol] ^{N×C/2} along the channel dimension. Then the decomposed feature map is sent to the average pool layer F_{avg}(Xₐ) and the maximum pool layer Fₘₐₓ(Xₘ) respectively. For the average pool layer, calculate the average value in the pool window, smooth the feature map and highlight the global information. In contrast, the maximum pool layer selects the maximum value in the pool window to effectively extract edges and other salient features. Subsequently, the feature mosaic operation combines the feature maps obtained from different pooling operations along the channel dimension, thus integrating multiple feature representations and enhancing the feature expression ability of the model. The following is the formulaic representation of Xₐ= [symbol] ^{N×C/2}, Xₘ= [symbol] ^{N×C/2} and the mosaic process of feature maps:

$${F}_{avg} ( {X}_{a} ) = \frac{1}{HW} {\sum }_{h = 1}^{H} {\sum }_{w = 1}^{W} {X}_{a} ( h , w )$$

$${F}_{max} ( {X}_{m} ) = \begin{matrix}H \\ max \\ h = 1\end{matrix} \begin{matrix}W \\ max \\ w = 1\end{matrix} {X}_{m} ( h , w )$$

$${X}_{concat} = {F}_{avg} ( {X}_{a} ) ‖ {F}_{max} ( {X}_{m} )$$

In Formula 1, H and W represent the height and width of the feature map, Xₐ(h,w) and Xₘ(h,w) represent the pixel values of the position (h,w) in the feature map, and | represent the connection operation. Finally, the local inter-channel interaction strategy and adaptive one-dimensional convolution structure are introduced. Through one-dimensional convolution, the model realizes the comprehensive information exchange between channels, thus enhancing the feature correlation between channels. The calculation formula of A-ECA is as follows:∥

$${y}_{c} = σ [ C 1 {D}_{k} ( {F}_{avg} ( {X}_{a} ) ‖ {F}_{max} ( {X}_{m} ) ) ] \times X$$

In Formula 2, σ represents sigmoid function, F_{avg}(Xₐ) represents average pooling, Fₘₐₓ(Xₘ) represents maximum pooling, and C1D represents one-dimensional convolution with k parameters. spatial attention mechanism (SAM) introduces relevant parts into bottleneck attention module to reduce the loss of spatial information caused by pooling layer. In order to further preserve the feature map, the pool layer is removed. In order to prevent the parameters from increasing significantly, we introduce depth separable convolution, and integrate the standard volume into two steps: depth convolution and point-by-point convolution, thus reducing the computational complexity of the model and making the network lighter. This is especially beneficial for complex models (such as attention mechanism) and helps to reduce the risk of over-fitting. Firstly, a 3×3 depth convolution is applied to capture the spatial information in the feature map y_{c}, while maintaining the relationship between channels, further enhancing the extraction of local features of the image. The processed feature map is convolved point by point for channel scaling. By reducing the number of channels, the computational complexity of the model is reduced, and lightweight feature representation is introduced to further refine features. Subsequently, another 3×3 depth convolution is applied to reduce the feature map of the channel to further introduce the spatial relationship. Finally, the feature map is recovered by point-by-point convolution. This convolution layer corresponds to the second convolution layer, and the channel is restored. SAM realizes dynamic attention distribution in image space through channel reduction and recovery and depth separable convolution. This operation helps the model pay more attention to the text area in the image, thus improving the performance of the model. SAM's formula is as follows:

$${w}_{s} = BatchNorm ( ( ( ( {y}_{c} * {DW}_{1} ) * {PW}_{1} ) * {DW}_{2} ) * {PW}_{2} ) \times {y}_{c}$$

In Formula 3, y_{c}= [symbol] ^{N×C} represents the output of channel convolution, where DW represents depth convolution and PW represents point-by-point convolution.

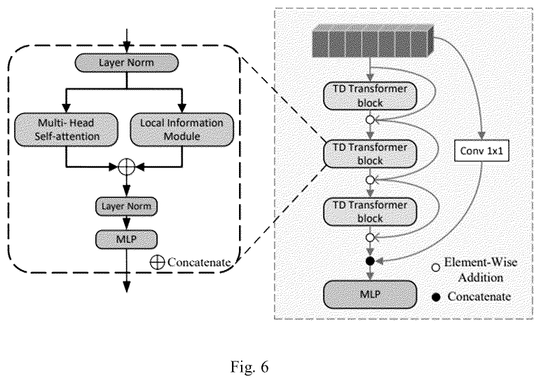

Hybrid text attention mechanism combines channel attention mechanism and spatial attention mechanism. Firstly, the channel attention mechanism dynamically distributes the attention between different channels, emphasizing the specific channel information that is important to the task, thus enhancing the abstraction and representation ability of the model. This is helpful to better capture the key features in text detection tasks, and ultimately improve the model performance. Secondly, the spatial attention mechanism enables the model to pay attention to a specific region of the input tensor, so as to deal with related features more intensively. Through spatial attention mechanism, the model can effectively locate and identify text regions, thus improving the accuracy and robustness of text detection. By making full use of the advantages of channel-level and spatial-level information, the hybrid text attention mechanism enables the model to better understand and process complex text images, thus improving the performance and effectiveness of text detection tasks. FIG. 6 shows the comparison between the effect of using hybrid text attention mechanism and baseline heat map.

### 2. Spatial Feature Fusion Module (SFFM):

As shown in FIG. 5, when the feature map is input from the backbone network to the multi-level feature fusion structure, the feature map with smaller receptive field is located at the bottom of the pyramid structure. In the process of backward fusion, these feature maps with smaller receptive fields are finally fused. In addition, when the number of input channels is small, the contribution of feature information with smaller receptive field to the fusion of feature information is relatively small, which leads to less processing of feature information with smaller receptive field and reduces their influence when it is finally output. However, the feature map with large receptive field is located at the highest level of the pyramid. In the process of backward fusion, the proportion of feature maps with large receptive fields gradually decreases. This causes the model to pay insufficient attention to the feature information with small receptive field, thus missing the detection of small-scale text in some images and failing to detect large-scale text completely in other images. Therefore, the spatial feature fusion module (SFFM) is introduced into the original multi-level feature fusion structure, aiming at properly fusing feature maps with smaller receptive fields and larger receptive fields.

SFFM mainly aims at effectively integrating the output features of low-level semantics and high-level semantics, thus enhancing the representation ability of features, enriching semantic information, and finally improving the model's understanding of image content and perception of texts of different scales. Because of the differences in the number of channels and feature scale, it is impossible to apply simple weighting operation to two groups of features. Therefore, SFFM feature fusion module is used to fuse these two features. As shown in FIG. 5, SFFM module accepts two inputs: one is low-level feature Xₛₚ= [symbol] ^{N×C/2}, and the other is high-level feature X_{cp}= [symbol] ^{N×C/2}. These two features are spliced first, and then processed by simple convolution operation and activation function. Then, the spatial attention mechanism is used to capture the correlation between different regions, thus effectively distinguishing text regions from background information in complex natural scenes. This module can better deal with the changes of text position and layout in the image, and finally obtain the final feature representation which combines different levels of information. The calculation formula is as follows:

$$S = BatchNorm ( Relu ( Conv ( concate ( [ {X}_{sp} , {X}_{cp} ] ) ) ) )$$

$$F = ( S \times SpatialAttention ( S ) ) + S$$

In Formula 4, concat stands for splicing operation; Conv stands for 3×3 convolution operation; Spatial attention refers to the spatial attention module, as shown in FIG. 5. The spatial attention mechanism in SFFM can capture the correlation between different regions in the input feature map more effectively, thus enhancing the model's perception of local structure. Based on the results of multi-layer feature fusion, the high-level information is first fused with the middle-level features in the original network, and then fused with the low-level features, and finally output. This design ensures that SFFM module only involves a few convolution operations and simple element-by-element multiplication and addition operations, without introducing additional computational overhead. Therefore, the model can extract text features of different scales more comprehensively and accurately when dealing with text detection tasks from the perspective of drones. This method not only solves the performance problem, but also avoids the extra calculation cost.

### 3. Text Detail Transformer (TDT):

In previous studies, control points are mainly located at the edge of text instances. for example, in DPText-DETR, points are sampled along the outer boundary of each text area. However, this feature of edge sampling usually contains many background attributes, which makes it difficult to focus only on text. In the subsequent TEXTBPN++, a boundary transformer module is proposed, which iteratively predicts the offset of each vertex pointing to the text boundary based on the learned rough boundary proposal. For each rough boundary represented by a closed polygon, the multi-head attention mechanism in the boundary transformer compares the global similarity, thus associating long-distance targets, but it is relatively weak in capturing text boundaries and local structures. This weakness leads to the poor adaptation effect of rough boundary proposal optimization on text boundary in the boundary iterative optimization module. In order to solve these challenges, we propose text detail transformer (TDT), which uses the strong local feature extraction ability of Convolutional Neural Network (CNN) to construct local feature extractor (LFE) and integrate it into the transformer. Its detailed architecture is shown in FIG. 6. Firstly, the input features are split along the channel dimension, and then the split components are sent to LFE and global feature extractor respectively. Here, the high-frequency mixer consists of group convolution operation and 1×1 convolution operation, while the global feature extractor is realized by multi-head attention mechanism. In terms of technical implementation, for the input feature map X= [symbol] ^{N×C}, it is decomposed into X₁= [symbol] ^{N×C}^{₁} and Xₕ= [symbol] ^{N×C}^{ₕ} along the channel dimension. The formulas of local feature extractor and global feature extractor are as follows:

$${Y}_{h} = Conv ( Relu ( BatchNorm ( GConv ( {X}_{h} ) ) ) )$$

$${Y}_{I} = MSA ( AvgPooling ( {X}_{I} ) )$$

In Formula 5, GConv represents 3×3 packet convolution, Conv represents 1×1 convolution, and MSA refers to the multi-head self-attention mechanism in the transformer.

The boundary iterative optimization module adopts the encoder-decoder structure, in which the encoder consists of three layers, and our proposed text detail transformer (TDT) has residual connection, and the decoder is a simple multi-layer perceptron (MLP), as shown in FIG. 6. Each encoder layer can be expressed as:

$${X}^{′} = X \times TD TransBlock ( X )$$

In Formula 6, X= [symbol] ^{N×C} represents the characteristic matrix of the boundary proposal. Each text detail transformer (TDT) has a standard architecture, including parallel local feature extractor, global feature extractor and a multi-layer perceptron network (MLP).

The main advantage of the proposed TDT is its flexibility in optimizing text boundaries, so that it can better deal with fuzzy or irregular text boundaries, thus improving the accuracy and robustness of text detection and recognition. This fusion method effectively integrates global and local information, makes use of long-distance dependence and local details, overcomes the limitations of single method, and provides stronger feature representation ability for text processing tasks. It can better refine the boundary information in the process of text boundary optimization and reduce the interference of background noise. Therefore, the final boundary contour can fit the text area more accurately.

The invention will be further illustrated by the following experiments:

### (1) Data Set

Total-Text: This data set contains 1,255 training images and 300 test images, providing word-level polygon labeling for texts with different directions and irregular shapes. The data set covers a variety of scenes, including outdoor scenery and buildings.

CTW1500: This data set includes 1,500 natural scene images, including 1,000 for training and 500 for testing. The data set is mainly characterized by curve text, covering a variety of scenes, such as outdoor scenery and urban streets.

Drone-text: This UAV perspective text data set contains 2,000 images, of which 1,600 are used for training and 400 are used for testing. The data set comes from the data taken by drones, covering the text data from UAV data sets such as Visdrone2019 and UAVid, showing various text images under different urban backgrounds, perspectives and lighting conditions. These images include not only ground texts, but also texts on shops and billboards. The data set is annotated with PPOCRLabel and converted into the text annotation format of Icdar2015. Each line in the markup file represents a text object, and the first eight digits are coordinate information (x1, y1, x2, y2, x3, y3, x4, y4), forming a polygon represented by four clockwise points. Among them, Unprocessed-img refers to the original image in the dataset, Annotated-img refers to the labeled image, and Label refers to the labeled file of the original data.

### (2) Implementation Details

In the experiment, the backbone network uses ResNet50. The size of the input image is set to 640×640, and the model is trained in 660 cycles, and the batch size is set to 12. The initial learning rate is set to 0.001, and the pre-training model is not used, and the attenuation is 0.9 every 50 cycles. Choose Adam as the optimizer. At the same time, data enhancement techniques such as random rotation, random flipping and random cropping are applied. The experimental environment consists of Python 3.8 and PyTorch 1.7.0 frameworks. The training is conducted on NVIDIA RTX A6000 GPU with 48 GB memory, and the CPU used is Intel® Xeon® Gold 6226r @ 2.9 GHz.

### (3) Evaluation Index

“R”, “P” and “F” stand for recall rate, accuracy rate and F-measure respectively. The performance of the algorithm is evaluated by accuracy, recall and F-measure, and its calculation method is as follows:

$$Precision = \frac{TP}{TP + FP}$$

$$Recall = \frac{TP}{TP + FN}$$

$$F = 2 \times \frac{Precision \times Recall}{Precision + Recall}$$

Among them, TP (true positive case) represents the real situation, FP (false positive case) represents the false positive case, and FN (false negative case) represents the false negative case.

TABLE 1
DADNet ablation experiments on Total-Text dataset:
hybrid text attention mechanism, spatial feature
fusion module and local feature extractor.

| [symbol] | [symbol] | | | | | |
|---|---|---|---|---|---|---|
| [symbol] | [symbol] | [symbol] | [symbol] | [symbol] | [symbol] | [symbol] |
| | | | 89.2 | 85.2 | 87.1 | 12.0 |
| [symbol] | | | 90.6 | 86.3 | 88.4 | 7.2 |
| [symbol] | [symbol] | | 91.2 | 86.3 | 88.7 | 5.5 |
| | | [symbol] | 91.6 | 84.3 | 87.8 | 6.9 |
| [symbol] | [symbol] | [symbol] | 91.9 | 85.9 | 88.8 | 5.7 |

HTAM stands for hybrid text attention mechanism, SFFM stands for spatial feature fusion module, and LFE stands for local feature extractor. “P”, “R” and “F” correspond to accuracy, recall and F-measure respectively.

TABLE 2
DADNet ablation experiments on Drone-text dataset:
hybrid text attention mechanism, spatial feature
fusion module and local feature extractor.

| [symbol] | [symbol] | | | | | |
|---|---|---|---|---|---|---|
| [symbol] | [symbol] | [symbol] | [symbol] | [symbol] | [symbol] | [symbol] |
| | | | 74.9 | 67.4 | 70.9 | 14.2 |
| [symbol] | | | 75.7 | 67.8 | 71.5 | 7.6 |
| [symbol] | [symbol] | | 76.0 | 69.8 | 72.7 | 5.5 |
| | | [symbol] | 75.2 | 68.3 | 71.6 | 7.4 |
| [symbol] | [symbol] | [symbol] | 80.0 | 73.0 | 76.3 | 6.0 |

HTAM stands for hybrid text attention mechanism, SFFM stands for spatial feature fusion module, and LFE stands for local feature extractor. “P”, “R” and “F” correspond to accuracy, recall and F-measure respectively.

### (4) Ablation Research

We conducted ablation research on Total-Text and Drone-text data sets to further verify the superior performance of text detection methods from the perspective of drones, and the effectiveness of HTAM, SFFM and LFE. Detailed experimental results are shown in Tables 1 and 2.

As shown in Tables 1 and 2, the introduction of HTAM significantly improves the performance of the two data sets. Specifically, the F-measure performance of HTAM on Total-Text dataset is improved by 1.3%, and that on Drone-text dataset is improved by 0.6%. On this basis, combined with SFFM, the module can capture and appropriately fuse the features of different levels, and improve the detection of text information at various scales without significantly increasing the computational overhead. On the Total-Text data set, SFFM contributed 1.6% of the F-measure improvement. On Drone-text data set, F-measure is improved by 2.0%. Finally, the introduction of LFE integrates all modules and achieves the most advanced results on both data sets. On the Total-Text data set, the accuracy increased by 2.7%, the recall rate increased by 0.7%, and the F-measure reached 88.8%, marking an increase of 1.7%. On the Drone-text data set, the accuracy increased by 5.1%, the recall rate increased by 5.6%, and the F-measure reached 76.3%, an increase of 5.4%.

The main function of LFE is to iteratively optimize the text boundary and reduce the interference of complex background. As shown in Table 1-2, LFE improves performance on both Total-Text and Drone-Text datasets. When LFE is introduced alone, the F-measure of both data sets increased by 0.7%, indicating its positive influence on boundary optimization. After the introduction of HTAM and SFFM, comparing the results with or without LFE, the Total-Text data set increased by 0.1%, while the Drone-Text data set increased by 3.6%. Total-Text data set is mainly composed of conventional text detection tasks. After HTAM and SFFM are introduced, the detection accuracy has been improved. Because most of the texts in this data set are horizontal and unaffected by background and angle interference, boundary optimization without LFE still achieves good results. On the contrary, Drone-Text dataset contains multiple perspectives and complex backgrounds. After HTAM and SFFM improve the text detection ability, LFE significantly refines the rough boundary of the detected complex text, which brings significant performance improvement.

On the Total-Text data set, the baseline model from the 300th to the 660th epoch and the F-measure statistics of DADNet. Every five epoch are evaluated, and a total of 72 data points are generated. Subsequently, the frequency distribution histogram is created to analyze the evaluation results of the model. It can be seen that the F-measure value of the model is significantly improved after the integration of each module.

(5) Comparisons with Previous Methods.

In order to verify the universality of this method, we compare it with other most advanced methods on three standard data sets. These data sets include two curve text benchmarks (Total-Text and CTW1500) and a data set for detecting text from an aerial perspective. The visual results of DADNet on different data sets, and the detailed numerical results are provided in Table 3-5.

TABLE 3
Comparison of DADNet and other methods
on the Total-Text dataset.

| | [symbol] | | | |
|---|---|---|---|---|
| [symbol] | [symbol] | [symbol] | [symbol] | [symbol] |
| [symbol] | [symbol] | 81.2 | 79.9 | 80.6 |
| [symbol] | [symbol] | 87.6 | 79.3 | 83.3 |
| [symbol] | [symbol] | 89.3 | 81.0 | 85.0 |
| [symbol] | [symbol] | 86.5 | 84.9 | 85.7 |
| [symbol] | [symbol] | 86.1 | 80.2 | 83.1 |
| [symbol] | [symbol] | 89.9 | 85.3 | 87.5 |
| [symbol] | [symbol] | 92.0 | 84.1 | 87.8 |
| [symbol] | [symbol] | 91.9 | 85.9 | 88.8 |

Total-Text: Total-Text data set is widely used in the field of arbitrary shape text detection. It contains a variety of text types, including multi-directional, horizontal and curved text lines, and is an ideal choice to verify the ability of our method in detecting arbitrary shape text. When testing this data set, the image is adjusted to be within the range of (640, 1024) while maintaining its aspect ratio. Thresholds thd and this are set to 0.3 and 0.85 respectively. The results of our method on the Total-Text data set are shown in the last column of Table 3. By comparison, it is obvious that our method performs better than the current mainstream models. Without using additional data sets, the F-measure reaches 88.8%, which is the highest performance without using external data. for example, compared with MixNet (87.8% for F-measure), which is the best performance at present, our method exceeds it by 1.0%. Table 3 provides detailed numerical results.

TABLE 4
Comparison of DADNet and other
methods on the CTW1500 dataset.

| | [symbol] | | | |
|---|---|---|---|---|
| [symbol] | [symbol] | [symbol] | [symbol] | [symbol] |
| [symbol] | [symbol] | 86.0 | 81.1 | 85.3 |
| [symbol] | [symbol] | 83.7 | 84.1 | 83.9 |
| [symbol] | | | | |
| [symbol] | [symbol] | 82.8 | 80.4 | 81.6 |
| [symbol] | [symbol] | 85.0 | 85.3 | 85.4 |
| [symbol] | | | | |
| [symbol] | [symbol] | 84.3 | 84.2 | 84.3 |
| [symbol] | [symbol] | 87.9 | 82.8 | 85.3 |
| [symbol] | [symbol] | 85.3 | 82.5 | 83.9 |
| [symbol] | | | | |
| [symbol] | [symbol] | 88.3 | 83.9 | 86.0 |

CTW1500: Compared with the word-level annotation of Total-Text, the curve text example in CTW1500 uses a polygon with 14 vertices for annotation, which brings greater challenges. Our method uses SFFM and TDT to better capture long-distance and local features to deal with such situations. When testing this data set, the image is also adjusted to be within the range of (640, 1024) while maintaining its aspect ratio, and the thresholds thd and this are set to 0.3 and 0.855 respectively. The results are shown in Table 4. Obviously, our model achieves 88.3% accuracy, 83.9% recall and 86.0% F-measure. Both accuracy and F-measure reach the best level, while the recall rate exceeds most recent models. Compared with TextFuseNet, the best performing method before, DADNet has improved accuracy by 3.3% and F-measure by 0.6% respectively. These results show that our DADNet has satisfactory performance.

TABLE 5
Comparison of DADNet and other methods
on the Drone-Text dataset.

| | [symbol] | | | |
|---|---|---|---|---|
| [symbol] | [symbol] | [symbol] | [symbol] | [symbol] |
| [symbol] | [symbol] | 69.7 | 66.6 | 68.1 |
| [symbol] | [symbol] | 70.7 | 65.8 | 68.2 |
| [symbol] | [symbol] | 72.4 | 64.7 | 68.3 |
| [symbol] + | [symbol] | 74.9 | 67.4 | 70.9 |
| [symbol] | [symbol] | 75.8 | 68.3 | 71.9 |
| [symbol] | [symbol] | 80.0 | 73.0 | 76.3 |

Drone-text: In order to show the diversity of this method in the UAV perspective scene, the model is trained with Drone-text data set. This data set contains a variety of complex Chinese scenes, including store signs, billboards, buildings, road signs and traffic signs. Due to the aerial perspective of UAV images, this data set contains rich text information and the same text examples from different perspectives. In addition, some text areas may be partially obscured or in the shadow, which will reduce the perceptibility of the model, especially for small-scale text examples. In addition, the wide field of vision provided by drones also increases the sensitivity to complex background interference. Therefore, this data set effectively simulates the diverse scenes encountered in the viewing angle setting of UAV, which brings significant challenges to text detection.

We choose the mainstream models including FAST, MixNet, DBNet++, TextPMs and TextBPN++, and compare them with our models. FAST designed an ultra-simple kernel function to simulate arbitrary shape text. At the same time, TextNet network is specially designed for text detection. MixNet designs a novel text detection backbone network FSNet, and uses the central transformer block to take advantage of the 1D manifold constraint of the scene text. TextPMs proposes an innovative segmentation detection method based on probability graph to realize accurate text instance detection. DBNet++ introduces an adaptive scale fusion module for scale robust feature fusion, and integrates the binarization process into the DB module in the segmentation network to optimize the segmentation network and DB module, thus producing more accurate results. TextBPN++ systematically proposes a unified coarse-to-fine framework for the detection of arbitrary-shaped texts, which enables accurate and efficient text boundary location without post-processing.

In order to verify the validity of the model, we use FAST, MixNet, DBNet++, TextPMs and TextBPN++ algorithms to detect it on Drone-text data set. The detailed test results are analyzed in Table 5. Our model achieves 80.0% accuracy, 73.0% recall and 76.3% F-measure in text detection, which represents the most advanced performance of text detection from the perspective of UAV. Compared with MixNet, the F-measure value of our model is 4.4% higher, and it performs significantly better in text detection based on UAV.

Compared with the related art, the UAV perspective text detection model based on boundary adaptation provided by the invention has the following beneficial effects:

In this paper, a text detection data set based on UAV is labeled, and a new text detection model is proposed for UAV perspective. Our model has made three key improvements to the framework of arbitrary shape text detection: first, the hybrid text attention mechanism enhances the perception of text areas; Secondly, the scale feature fusion module optimizes the processing of text features under different scales; Thirdly, the text detection transformer reduces the interference of complex background by integrating local features, and realizes more accurate text boundary location without complex post-processing. A large number of experiments show that our method using ResNet50 backbone network performs well on public data sets and text detection data sets based on drones.

The above is only an embodiment of the present invention, which does not limit the patent scope of the present invention. Any equivalent structure or equivalent process transformation made by using the contents of the specification and drawings of the present invention, or directly or indirectly applied to other related technical fields, are equally included in the patent protection scope of the present invention.

What is claimed is:

1. A UAV perspective text detection model based on boundary adaptation, characterized by comprising the following components: a hybrid text attention mechanism, which is used to strengthen the perception of text areas in the feature extraction stage; a spatial feature fusion module, which is used to adaptively fuse text features of different scales, and to effectively integrate the output features of low-level semantics and high-level semantics, so as to enhance the representation ability of features, enrich semantic information, and finally improve the model's understanding of image content and perception of texts of different scales; a text detail transformer, including local feature extractor, which is used to optimize the iterative thinning process of text boundaries.

2. The UAV perspective text detection model based on boundary adaptation according to claim 1, characterized in that the hybrid text attention mechanism is divided into two parts: a channel attention mechanism and a spatial attention mechanism, so as to reduce detection omissions caused by visual angle change, illumination shadow and occlusion.

3. The UAV perspective text detection model based on boundary adaptation according to claim 1, characterized in that the spatial feature fusion module realizes the fusion of high-level and low-level features through weighted feature maps, thus enhancing the detection capability of the model for texts of different scales.

4. The UAV perspective text detection model based on boundary adaptation according to claim 1, characterized in that the text detail transformer improves the ability of the model to extract local information from the feature map by introducing a local feature extractor into the transformer block, thereby optimizing the refinement of the text boundary.

5. The UAV perspective text detection model based on boundary adaptation according to claim 2, characterized in that the channel attention mechanism introduces an efficient channel attention aggregation mechanism: the detailed texture features related to the text boundary are extracted by maximizing the pool operation of the input feature map, so as to enhance the perception of the text boundary; at the same time, the overall information of the image area is captured by average pooling, which is convenient to understand the overall image structure and background, which are contextual features related to the target; therefore, these two processing methods are simultaneously applied to the input feature map; after processing, the two generated feature maps are connected, and the spatial information of the feature maps is aggregated by merging the average pooled feature and the maximum pooled feature.

6. The UAV perspective text detection model based on boundary adaptation according to claim 1, characterized in that the channel attention mechanism also introduces a local cross-channel interaction strategy and an adaptive one-dimensional convolution structure to realize more comprehensive cross-channel information exchange, and obtains different weights corresponding to different channels on the feature map through network learning, thereby providing more accurate attention information along the channel dimension.

7. A method for UAV perspective text detection using the UAV perspective text detection model based on boundary adaptation according to claim 1 which comprises the following steps: using hybrid text attention mechanism to extract image features; multi-scale features are fused by spatial feature fusion module; text detail transformer is used to iteratively optimize the text boundary to improve the accuracy of detection.
